(19) United States
(12) Patent Application Publication
(10) Pub. No.: US 2005/0111088 A1
(43) Pub. Date: May 26, 2005

(54) Microscope camera

(75) Inventors: Johannes Winterot, Jena (DE); Johannes Knoblich, Jena (DE); Tobias Kaufhold, Jena (DE); Hanna Tielebier, Quitzoebel (DE); Guenter Osten, Jena (DE)

Correspondence Address: Gerald H. Kiel, Esq.;REED SMITH LLP, 599 Lexington Avenue, New York, NY, 10022-7650, US

(73) Assignee: CARL ZEISS JENA GmbH

(21) Appl. No.: 10/993,660

(22) Filed: Nov. 19, 2004

(30) Foreign Application Priority Data
Nov. 21, 2003 (DE) 103 55 527.7

(51) Int. Cl. G02B 21/00

(52) U.S. Cl. 359/368; 359/363

(57) ABSTRACT

The invention is directed to a microscope camera which is suitable particularly for recording digital images in stereomicroscopy. The complete camera, including a deflecting element for one of the stereo beam paths, image recording chip, control unit and processing unit, monitor and data interfaces, is integrated in an intermediate tube.

### CROSS-REFERENCE TO RELATED APPLICATION

This application claims priority of German Application No. 103 55 527.7, filed Nov. 21, 2003, the complete disclosure of which is hereby incorporated by reference.

### BACKGROUND OF THE INVENTION

a) Field of the Invention

The invention is directed to a microscope camera which is suitable particularly for recording digital images in stereomicroscopy.

b) Description of the Related Art

The use of digital cameras in microphotography is increasingly taking over from conventional miniature microphotography. With digital cameras, the microscope image can be stored on storage media such as memory sticks and PC cards or in the PC and can be processed with corresponding software. The image data can also be reproduced on video monitors or by video printers. As is already known from miniature microphotography and video microscopy, digital cameras can be adapted to the microscope in different ways.

a) Adapting Digital Compact Cameras with Fixed Objective

Commercially available digital compact cameras are used for taking microscope by adapting them to existing photo outputs of microscopes. This requires a mechanical-optical adapter which
can be attached to the eyepiece connection piece or photo connection piece;
fixes the digital compact camera in the optical axis of the microscope; and
contains imaging optics (eyepiece, projection lens, lens system) which image the microscope image, together with the camera objective which is adjusted to infinity (o), in the image plane of the camera, wherein the beam path guided to the camera can be the direct microscope beam path or the partial beam path deflected out of the direct microscope beam path by a suitable splitter element.

In order that the camera image is not cropped and fills up the format when the camera objective zoom moves in the telephoto range (optical zoom range) direction and also remains thus after a determined focal length of the objective, the exit pupil of the beam path after the imaging optics of the adapter must fit in the entrance pupil “tube” (the position and size of the entrance pupil changes as the focal length changes when zooming) of the camera objective that is adjusted to infinity (∞). This means that the exit pupil of the adapter optics must be at the greatest possible distance above the adapter optics and the portion of the adapter with the camera connection must be displaceable and clampable with respect to the adapter part of the imaging optics over a sufficiently large displacement range in direction of the optical axis. This adjustment, and subsequently the microscope image, can be observed on the LCD monitor or in the viewfinder of the camera. An adapting arrangement of this kind is offered by the present applicant in the form of eyepiece adapters for the DV4 and DR stereo microscopes by Zeiss.

An embodiment example for this type of adapting is shown in FIG. 1. In one of the stereo microscope beam paths 1 coming from the body of the stereo microscope into the eyepiece connection piece 2, the microscope intermediate image 3 is imaged by the eyepiece lens 5 toward infinity in the camera objective 7 which is adjusted to infinity (∞) and by the latter in the image plane 10 of the digital compact camera 11. The lower adapter part 4 with the eyepiece lens 5 is screwed onto the eyepiece connector 2, the upper part of the adapter 6 with the camera connection is screwed into the thread of the camera objective 7. The exit pupil 8 of the eyepiece lens 5 lies at the greatest possible distance A above the eyepiece lens 5. The upper part of the adapter 6 with camera 11 is displaced relative to the lower adapter part 4 in the direction of the optical axis. When the exit pupil 8 of the eyepiece lens 5 lies in the entrance pupil “tube” 9 of the camera objective 7, the upper part of the adapter 6 with the camera 11 is aligned with the microscope image and is fixed on the lower adapter part 4 by means of clamping screw 12.

Other embodiment forms of such adapters (with a holder in the objective thread, in the camera tripod thread or in a shape adapted to the camera) are described in DE 20010421, U.S. 2002/0012045 A1, U.S. 2001/0048549, DE 29821977, and U.S. Pat. No. 5,835,807.

All of these solutions have the drawback that these adapters must be adapted essentially to the optical data of the digital camera and, therefore, in principle, each new digital camera needs its own adapter in order to achieve optimal image quality.

b) Adapting digital Mirror Reflex Camera Base Bodies without an Objective

Adapting this camera without an objective to connection pieces of the video or photo output of a stereo microscope is possible when the microscope intermediate image lies at a defined distance above the supporting surface of the connection piece. The planes of the eyepiece intermediate image and camera image are parfocal. This kind of adaptation requires mechanical-optical adapters
which can be attached to the connection piece of the video/photo output at a defined distance of the microscope intermediate image above the supporting surface;
which fix the digital compact camera in the optical axis of the microscope by means of a T2 connection and objective changing point in the optical axis of the microscope; and
by means of which the microscope intermediate image lies in the sensor planes of the camera directly (without optics) or in a magnified manner (with optics=image displacement system), wherein the beam path guided to the connection piece of the video/photo output can be the deflected, direct microscope beam path or the partial beam path that is deflected out of the direct microscope beam path by a suitable splitter element.

FIG. 2 and FIG. 3 show two embodiment examples of possible adaptations. The connection piece 13 of the video/photo output of a stereo microscope is designed in such a way that the microscope intermediate image 14 is formed at a defined distance B above the supporting surface of the connection piece 13 in one of the stereo microscope beam paths coming from the body of the stereo microscope. After the camera 17 is aligned with the microscope image, the adapter is fixed in the connection piece 13 by means of a clamping screw 18. In the first embodiment example in FIG. 2, the digital mirror reflex camera 17 is adapted to the connection piece 13 of the video/photo output by a commercially available T2 adapter 16 which matches the camera and by a T2 connector 15. The T2-connector 15 with the standardized T2 male thread is designed in such a way that it can be attached to the connection piece 13 and its mounting height is constructed in accordance with the defined distance B and the standardized T2 flange focal length or mounting dimensions, so that the microscope intermediate image 14 lies in the sensor plane of the camera.

In the second embodiment example in FIG. 3, the digital mirror reflex camera 17 is adapted to the connection piece 13 of the video/photo output by a commercially available T2 adapter 16 which matches the camera and by a T2 connection for mirror reflex cameras 19. The T2 connection for mirror reflex cameras 19 can be attached to the connection piece 13. It contains image displacement optics 20 which image the microscope intermediate image 14 in a magnified manner from the defined distance B in an image plane 21 lying farther above. The image plane 21 lies above the T2 connection in accordance with the standardized T2 mounting dimensions so that the image plane 21 is likewise situated in the sensor plane of the camera.

It is disadvantageous that the adaptation of digital mirror reflex cameras without objective by means of the T2 connection is based on structural component parts for adapting 35mm miniature film mirror reflex cameras without objective by means of the T2 connection. When adapting with the T2 connector without optics, the diagonals of the surface sensors of digital mirror reflex cameras (approximately 33 . . . 17 mm) are greater than or equal to the microscope intermediate image. The image format detected by the digital mirror reflex cameras is cropped to some extent. When adapting with magnifying image displacement optics in the T2 connection for mirror reflex cameras, the diagonals of the surface sensors of digital mirror reflex cameras (approximately 33 . . . 17 mm) are less than the magnified image (approximately 44 mm) for miniature mirror reflex cameras. Only a more or less large image section is detected. In order to reproduce the largest possible image sections without cropping, T2 connections with special factors of the magnification optics would be necessary for every size of the surface sensors.

c) Adapting Digital Video Cameras with, e.g., C-Mount Connection

Examples of digital video cameras with C-mount connection are the Olympus DP 10 and DP 50, the Nikon DXM1200, etc. In addition to the outer dimensions determined by the intended use, the chip size (standardized in inches) is an important distinguishing feature. It is possible to adapt this camera to the connection piece of the video/photo output of a stereo microscope when the microscope intermediate image is at a defined distance above the supporting surface of the connection piece. The planes of the eyepiece intermediate image and the camera image are parfocal. In the case of the Olympus DP 10, the camera image can be observed on the LCD monitor of the camera.

This type of adaptation requires mechanical-optical adapters
which can be attached to the connection piece of the video/photo output at a defined distance of the microscope intermediate image above the supporting surface;
which fix the digital video camera in the optical axis of the microscope by the C-mount connection; and
by means of which the microscope intermediate image lies in the sensor planes of the camera directly (without optics) or so as to be reduced by a factor determined by chip size and intermediate image size (with optics =image displacement system), wherein the beam path guided to the connection piece of the video/photo output can be the deflected, direct microscope beam path or the partial beam path deflected out of the direct microscope beam path by a suitable splitter element.

FIG. 4 and FIG. 5 show two embodiment examples of possible adaptations. The connection piece 13 of the video/photo output of a stereo microscope is designed in such a way that the microscope intermediate image 14 is formed at a defined distance B above the supporting surface of the connection piece 13 in one of the stereo microscope beam paths 1 coming from the body of the stereo microscope. After the camera 23 is aligned with the microscope image, the adapter is fixed in the connection piece 13 by means of a clamping screw 18. In the first embodiment example in FIG. 4, the digital video camera 23 is adapted to the connection piece 13 of the video/photo output by a C-mount adapter 22 which matches the camera. The C-mount adapter 22 with the standardized C-mount connection is designed in such a way that it can be attached to the connection piece 13 and its mounting height is constructed in accordance with the defined distance B and the standardized C-mount mounting dimensions, so that the microscope intermediate image 14 lies in the sensor plane of the camera.

In the second embodiment example in FIG. 5, a digital video camera with a smaller chip size 26 is adapted to the connection piece 13 of the video/photo output by a C-mount adapter 24 matching the camera. The C-mount adapter 24 can be attached to the connection piece 13. It contains image displacement optics 25 which image the microscope intermediate image 14 from the defined distance B in another image plane 26 located below it in a reduced manner. The image plane 26 lies above the C-mount connection corresponding to the standardized C-mount mounting dimension so that the image plane 26 likewise lies in the sensor plane of the camera.

These solutions have a number of drawbacks. For each size of camera chip, an adapter must be selected which matches it. For adapting digital video cameras with smaller chip sizes (⅔″-½″-⅓″-¼″) by means of the C-mount adapter without optics, only an image section that is reduced to some extent is detected from the microscope intermediate image. When digital video cameras are adapted by means of a C-mount adapter with image displacement optics which are excessively reduced for the respective camera chip, the image format is not completely filled but is cut off to some extent.

d) Digital Camera Integrated in a Compact Microscope

The portable video microscope PV 10 by Olympus is known and comprises the individual components of video camera with illumination, cable, control unit and LCD monitor. Attaching the video camera to the microscope stand allows documentation of the microscope image which can be stored in the control unit on a PC card. The video monitor, video printer and PC can be connected to the control unit and can be operated with the latter.

The Sony company offers video microscope models TW-TL1S, TW-TL1SP, TW-TL10S, TW-TL10SP, TW-TL5MP and TW-TL10MP in which the microscope image can be observed without an eyepiece on a 7-inch LCD display of the microscope, the output data can be reproduced on a video monitor or video printer or can be sent to a PC as input data. In addition, with the TW-TL5MP and TW-TL10MP, it is possible to store the displayed monitor image on the memory stick storage medium. The images stored on the memory stick can be retrieved and displayed on the monitor or loaded on the PC subsequently for further processing. The image reproduction device and image storage device are always connected to a compact microscope without an additional mechanical-optical adapter.

FIG. 6 shows an embodiment example of the TW-TL . . . S video microscopes. FIG. 7 shows an embodiment example of the TW-TL . . . MP video microscopes. The TW-TL . . . S and TW-TL . . . MP video microscopes, both including illumination and control electronics, are designated respectively by 28 and 34. The swivelable video camera is designated by 29, the LCD monitor is designated by 30, the S-video output is designated by 3 1, the composite video output is designated by 32, the input of the DC power supply is designated by 33, the USB output is designated by 35, and the memory stick with insert is designated by 36.

In the TW-TL5MP and TW-TL10MP video microscopes, the digitized photo/video image recording system is integrated in the microscope by its outputs. Digital photo and video cameras need no longer be externally attached as was usual in conventional photo microscopes with integrated photo/video outputs.

e) Digital Camera Unit as Intermediate Tube with image Deflection

Intermediate tubes in which the microscope beam path is deflected to photoelectric sensors for light measurement by beam splitting or by switchable mirrors followed by optics are known from the microphotographic devices with exposure measuring devices and control devices offered by almost all microscope manufacturers, e.g., the MC200 and MC80 microphotographic camera attachment systems by the present applicant, the MPS 30/60 Photoautomats by Leica, the FX III photomicrographic system by Nikon, and the PM-IOAK35/20/30 automatic photomicrography systems by Olympus. The measurement field size, measuring accuracy and measurement principle determine the imaging ratios and imaging quality of the optics for light measurement. In another embodiment form of intermediate tubes of this kind, the photoelectric sensor is a video camera or a CCD video camera. The image on the sensor of the video camera is used for determining the exposure time of a microphotographic camera and/or for operating a passive autofocus system; but it can also be observed on the monitor. A method of this kind is described in DE 19517476 A1. In another embodiment form of an intermediate tube of this kind, the photoelectric sensor is an analog video camera with digital control. Such known designs include the Leica IC A video module with integrated CCD and PAL/NTSC camera control and the Leica IC A-180 video module with integrated CCD and PAL/NTSC camera control. In both cases, virtually the entire microscope intermediate image is imaged by suitable optics on the camera sensor with a quality suitable for image reproduction.

Adaptation of this kind is carried out with intermediate tubes
which are used directly between the microscope body and observing tube;
in which beam splitters or deflecting mirrors, sensor adapter optics, CCD camera sensors and camera control are integrated and in which the beam splitter, deflecting mirror, sensor adapter optics, and CCD camera sensor are fixed in the optical axis of the deflected microscope beam path; and
whose sensor adapter optics are adapted to the dimensions of the microscope beam path and to the size of the CCD camera sensor (reduction by a factor determined by the size of the chip and intermediate image).

FIG. 8 shows an embodiment example of an adaptation of this type. The intermediate tube 37 is inserted between the microscope body 45 and the observing tube 46. In the intermediate tube 37, a splitter prism 39 is arranged in one of the stereo microscope beam paths l coming from the body of the stereo microscope and deflects a portion of this beam path into the camera beam path 38, where optics 40 arranged immediately after the splitter prism 39 image the microscope intermediate image 3 in a reduced manner in a camera image plane 41 located on the sensor inlet surface of the CCD chip 42. The planes of the microscope intermediate image 3 and camera image plane 41 are parfocal. The image signal coming from the CCD chip 42 is processed and digitized in the camera control 43 which is likewise integrated. This video signal can be read off at the video output 44. The microscope image can be observed on the video monitor without an additional video/photo tube and independent from the eyepiece and can be printed by video printers. The digital image processing in the PC additionally requires a computer with a framegrabber. Simple digital microphotography is not possible.

### OBJECT AND SUMMARY OF THE INVENTION

Therefore, it is the primary object of the invention to overcome the disadvantages of the prior art and to provide a simple, compact arrangement for realizing digital photography, particularly for stereo microscopes.

This object is met by a microscope intermediate tube with integrated camera part comprising a microscope intermediate tube which can be inserted between a microscope body and an observing tube. A deflecting element is provided which can be fixedly arranged in or switched into one of the microscope beam paths and which deflects this beam path in its entirety or deflects-a portion thereof to imaging optics which image the microscope intermediate image on an image recording chip. The microscope intermediate tube containing control electronics for the image recording chip, an image processing unit, and an image display unit.

### DESCRIPTION OF THE PREFERRED EMBODIMENTS

According to the invention, the arrangement comprises a stereo microscope intermediate tube which is to be inserted directly between the microscope body and the observing tube and which has an integrated deflecting element that deflects the beam path of a stereo channel into the camera beam path, which is likewise integrated, where optics image the microscope intermediate image in a reduced manner on a CCD chip or on an adequate sensor (e.g., C-MOS sensor), and a camera control which digitizes the camera signal and which enables, independent of eyepieces and without additional video/photo tube, digital zooming of the image, reproduction of the image on an LCD monitor arranged at the intermediate tube, digital photography of the image on a storage medium which can be inserted into the intermediate tube and read on the PC, output of the image via a suitable video output and a PC-compatible interface.

According to a preferred embodiment form of the present invention, a deflecting element is arranged in or can be inserted in one of the stereo microscope beam paths, which deflecting element deflects this beam path completely or deflects a portion thereof to imaging optics which image the microscope intermediate image of the stereo zoom on the CCD chip of digital compact camera analog control electronics in a reduced manner so as to circumscribe the format and in an optimal manner with respect to the positions of the exit pupils of the stereo zoom. The CCD chip printed circuit board is connected to digitizing control electronics which process the camera signal and which are constructed in a manner analogous to the control electronics of a digital compact camera (e.g., Sony DSC-F707) and it is therefore possible, as is known from digital compact cameras, to carry out setup adjustments and function adjustments also at the stereo microscope intermediate tube with integrated camera part, to digitally zoom the microscope image and display it on an LCD monitor that is arranged so as to be swivelable and/or tiltable at the intermediate tube, to store the microscope image on a storage medium (e.g., memory stick) which can be inserted into the intermediate tube and read on the PC, and to read off the image data for image reproduction on a video monitor or video printer on a suitable video output or, for image reproduction and image processing, on a suitable PC-compatible interface (e.g., USB) at the computer. In the second stereo microscope beam path not deflected to the camera, an element which balances the transmission or the glass path in the camera beam path is arranged in or can be inserted in the first camera beam path when splitting is carried out.

### BRIEF DESCRIPTION OF THE DRAWINGS

In the drawings:

FIGS. 1-8 show prior art solutions or solutions which have inherent objections in their construction.

Preferred embodiment examples of the invention will be described more fully with reference to the drawings in FIGS. 9 to 12.

FIG. 9 shows the principle of the stereo microscope intermediate tube with integrated camera part in which one of the stereo microscope beam paths is deflected into the photographic beam path by a stationary splitter prism and the CCD camera sensor is arranged in this deflected stereo microscope beam path.

As in FIG. 9, FIG. 10 shows the principle of the stereo microscope-intermediate tube with integrated camera part, but in which the one stereo microscope beam path is deflected into the photographic beam path by a stationary splitter plate.

As in FIG. 9, FIGS. 11a/11b show the principle of the stereo microscope intermediate tube with integrated camera part, but in which the one stereo microscope beam path is deflected into the photographic beam path by a switchable mirror.

FIG. 12 shows the principle of the stereo microscope intermediate tube with integrated camera parts for 3D viewing in which both stereo microscope beam paths are deflected into the camera beam paths by stationary splitter prisms and a CCD camera sensor is arranged in each of the camera beam paths.

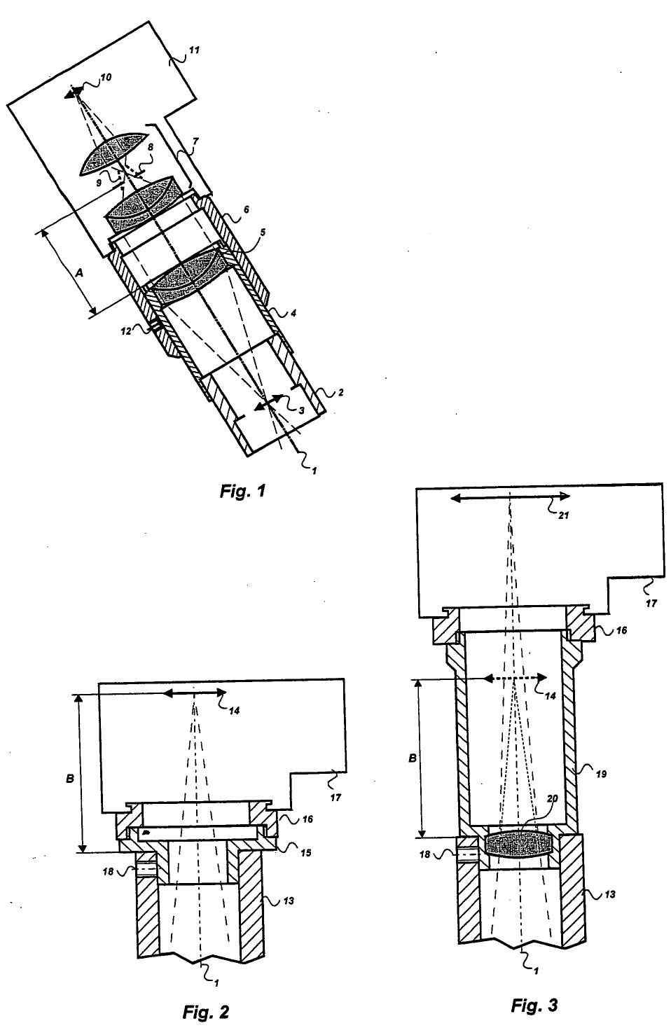

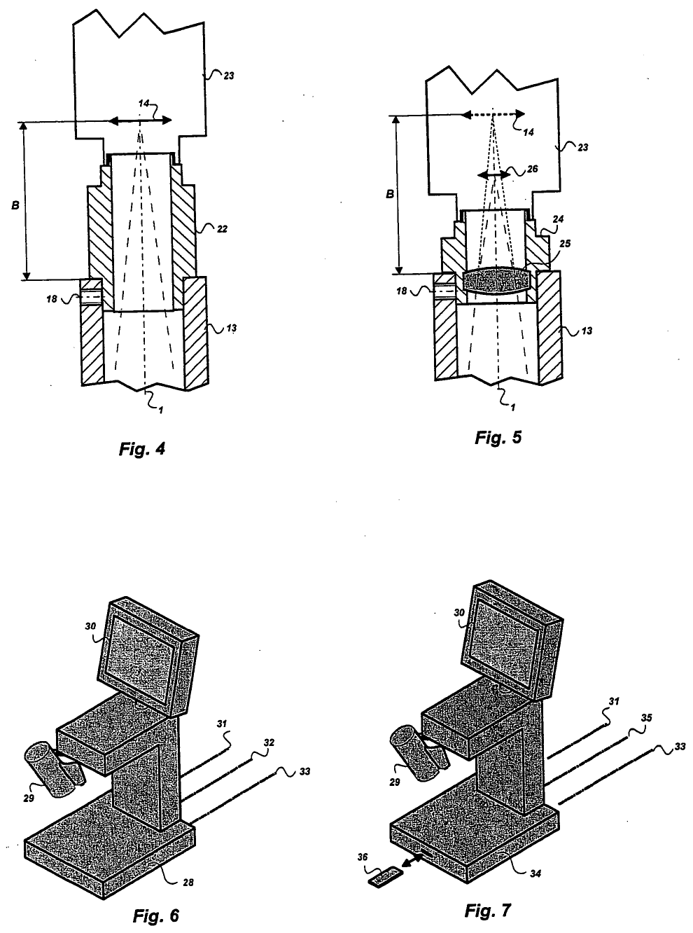

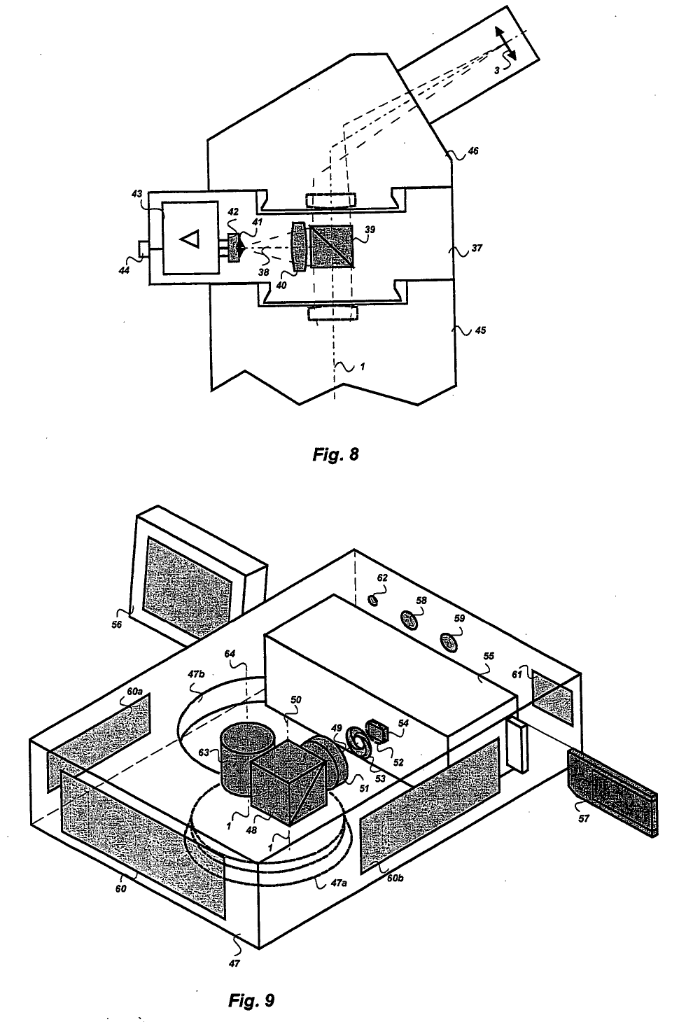

### DESCRIPTION OF THE PREFERRED EMBODIMENTS

In the following, the stereo microscope intermediate tube with integrated camera part will be described in detail with reference to FIG. 9.

One of the stereo microscope beam paths 1 coming from the body of the stereo microscope runs from below in the stereo microscope intermediate tube 47 into a splitter prism 48 where it is split into the photographic beam path 49 and into the beam path 50 which exits again from the stereo microscope intermediate tube 47 in the axis of the incident beam path 1. In the photographic beam path 49, imaging optics 51 are arranged after the splitter prism 48. These imaging optics 51 image a reduced microscope intermediate image of the stereo zoom 52 through a diaphragm/shutter system 53 onto the CCD chip 54 of integrated digital compact camera analog control electronics 55. The diaphragm/shutter system 53 and the CCD chip 54 belong to the digital compact camera analog control electronics 55. The image signals are processed in the digital compact camera analog control electronics 55 in such a way that the microscope image can be digitally zoomed, displayed on an LCD monitor 56 that is arranged so as to be swivelable and tiltable at the intermediate tube 47, and stored on a storage medium 57 that can be inserted into the intermediate tube and read at the PC, and in such a way that the image signals can be read off at a video output 58 and a PC-compatible interface 59. The setup, adjustment of the function parameters of the digital compact camera analog control electronics 55, and the triggering of the digital exposure are carried out by means of controls in the control panels 60, 60a and 60b. Power is supplied to the camera part via the BUS interface 61 which can preferably be a CAN bus interface (CAN=Controller Area Network) by which the exposure of digital recordings can also be triggered by a central control part. The socket for connecting photo accessories to the stereo microscope intermediate tube 47 is designated by 62. The other one of the stereo microscope beam paths 1 coming from the body of the stereo microscope traverses a glass body 63 which corresponds to the glass path of the splitter prism 48 and in which the light intensity is reduced to the extent that the beam path 64 exiting from the glass body 63 has the same light intensity as the other beam path 50 exiting from the stereo microscope intermediate tube 47.

The dovetail ring for inserting the stereo microscope intermediate tube 47 into the microscope body is designated by 47a. The dovetail ring receptacle for inserting the observing tube into the stereo microscope intermediate tube 47 is designated by 47b.

FIG. 10 and FIG. 11 show two other variants for coupling out the photo beam path in the stereo microscope intermediate tube. In FIG. 10, one of the stereo microscope beam paths 1 is split into a photographic beam path 49 and an exiting beam path 50 by a stationary splitter plate 64. Due to the 45-degree position of the splitter plate 65, the exiting beam path 50 has an axial offset v relative to the entering stereo microscope beam path 1; the center of the dovetail ring receptacle 47b for the insertion of the observing tube is aligned with this axial offset v. The other stereo microscope beam path 1 traverses a stationary glass plate 66, corresponding to the glass path the glass path of the splitter plate 65, which is inclined at 45° and which likewise causes the axial offset v between the entering stereo microscope beam path 1 and the exiting stereo microscope beam path 64 and in which the light intensity is reduced to the extent that the exiting beam path 64 has the same light intensity as the other split exiting beam path 50. In FIG. 11a, one of the stereo microscope beam paths 1 is deflected into he photographic beam path 49 with full light intensity by the switched on 90-degree mirror 67. In FIG. 11b, this stereo microscope beam path 1 is also the exiting beam path 50. The light intensities of the exiting beam paths 50 and 64 are identical. No optical elements are required in the other stereo microscope beam path 1.

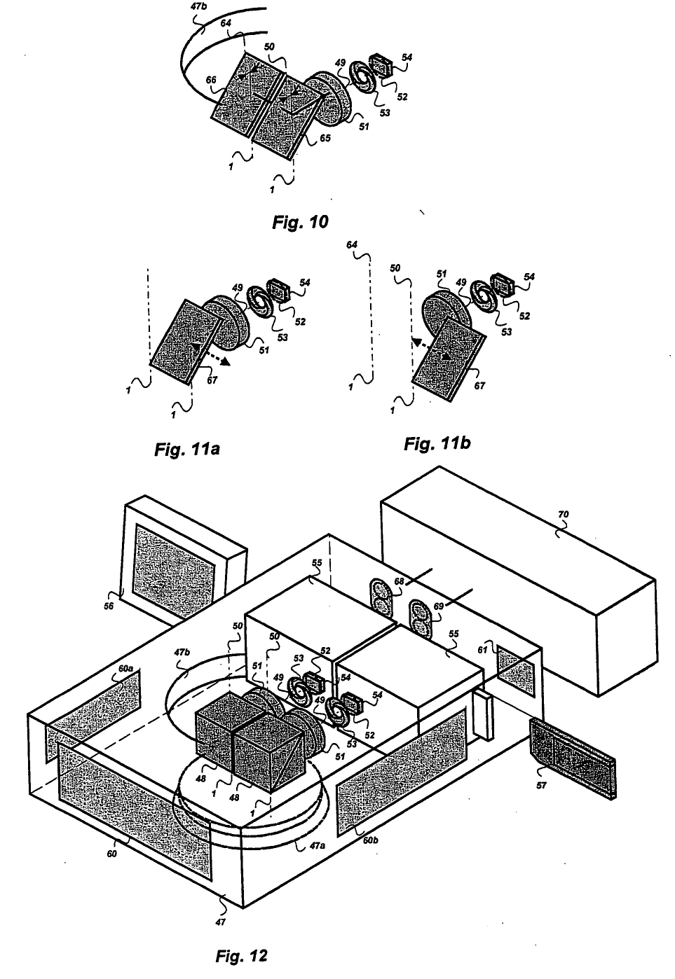

FIG. 12 illustrates the principle of the stereo microscope intermediate tube with two integrated camera parts for 3D observation with shutter glasses or polarizing glasses or with autostereoscopic image reproduction without glasses.

Both of the stereo microscope beam paths 1 coming from the body of the stereo microscope run from below in the stereo microscope intermediate tube 47 into a splitter prism 48 where they are split into the photographic beam path 49 to the camera and the beam path 50 which exits the stereo microscope intermediate tube 47 again in the axes of the incident beam path 1. In the photographic beam paths 49, imaging optics 51 are arranged after the splitter prisms 48. These imaging optics 51 image the reduced microscope intermediate images of the stereo zoom 52 through a diaphragm/shutter system 53 onto the CCD chip 54 of the integrated digital compact camera analog control electronics 55 associated with each beam path. The diaphragm/shutter system 53 and the CCD chip 54 belong to the integrated digital compact camera's analog control electronics 55. The image signals are processed in the digital compact camera's analog control electronics 55 in such a way that the microscope image of a photographic beam path can be displayed on an LCD monitor 56 that is arranged so as to be swivelable and tiltable at the intermediate tube 47 and can be stored on a storage medium 57 that can be inserted into the intermediate tube and read at the PC, and in such a way that the microscope image of both photographic beam paths can be digitally zoomed, and in such a way that the signals of the images from both photographic beam paths can be read off in pairs at video outputs 68 and PC-compatible interfaces 69 for processing in the 3D observation unit 70. As in FIG. 9, the control panels for setup and adjustment of the function parameters are designated by 60, 60a and 60b, the CAN BUS interface with power supply and external trigger signal is designated by 61, the dovetail ring for inserting the stereo microscope intermediate tube 47 into the microscope body is designated by 47a, and the dovetail ring receptacle for inserting the observing tube in the stereo microscope intermediate tube 47 is designated by 47b.

As can be seen from the preceding description, this solution is particularly advantageous for the user because, with the stereo microscope intermediate tube to be inserted between the microscope body and the observing tube, the microscope image can be reproduced on an LCD monitor arranged at the intermediate tube independent of eyepieces and without additional video/photo attachments, digitally zoomed, digitally photographed on a storage medium which can be inserted into the intermediate tube and read at the PC, and prepared and described for reproduction on video monitors and video printers and for digital image processing at the PC. The image reproducing system is integrated in the intermediate tube and the cameras need no longer be externally mounted. The reproduction of the microscope image on an LCD monitor arranged at the intermediate tube offers the possibility of monocular observation or observation without eyepieces. With this solution, it is possible to integrate image recording systems in stereo microscope components. Further, the invention has the advantage that the imaging of the microscope intermediate image of the stereo zoom is optimized in a format-circumscribing manner in accordance with the size of the CCD chip and with respect to the positions of the exit pupils of the stereo zoom.

The realization of the invention is not limited to the embodiment examples shown herein and further developments with knowledge of the art do not lead to a departure from the scope of protection of the patent claims.

In particular, in addition to CCD chips, other digital image recording sensors such as CMOS chips can also be used and the integrated image generation can also be based on other principles, e.g., OLEDs or the like

While the foregoing description and drawings represent the present invention, it will be obvious to those skilled in the art that various changes may be made therein without departing from the true spirit and scope of the present invention.

1. A microscope intermediate tube with integrated camera part comprising:
a microscope intermediate tube which can be inserted between a microscope body and an observing tube;
a deflecting element which can be fixedly arranged in or switched into one of the microscope beam paths and which deflects this beam path in its entirety or deflects a portion thereof to imaging optics which image the microscope intermediate image on an image recording chip; and
said microscope intermediate tube containing control electronics for the image recording chip, an image processing unit, and an image display unit.

2. The microscope intermediate tube according to claim 1 with a data interface and/or an interface for an external storage medium.

3. The microscope intermediate tube according to claim 1 with a control unit and operating unit for adjusting recording parameters or display parameters and/or for triggering image recordings.

4. The microscope intermediate tube according to claim 1 for use in a stereo microscope with two observation beam paths, wherein at least one of the observation beam paths is deflected by the deflecting element to the image recording chip.

5. The microscope intermediate tube for a stereo microscope according to claim 4, wherein a deflecting element which deflects the observation beam path to one or more image recording chips is associated with each observation beam path.

6. The microscope intermediate tube for a stereo microscope according to claim 5, wherein image data from the two observation beam paths can be provided as an output at a data interface and/or an interface for an external storage medium.

7. The microscope intermediate tube for a stereo microscope according to claim 6, wherein a system for digital 3D display can be connected to the data interface.
